(19) United States
(12) Patent Application Publication
(10) Pub. No.: US 2012/0110922 A1
(43) Pub. Date: May 10, 2012

(54) RAIN GUTTER GAURD AND METHOD FOR INSTALLATION

(76) Inventor: Ben Hawes, Fircrest, WA (US)

(21) Appl. No.: 12/939,944

(22) Filed: Nov. 4, 2010

(51) Int. Cl. E04D 13/076; B23P 11/00

(52) U.S. Cl. 52/12; 29/428

(57) ABSTRACT

The invention described herein relates to an apparatus that prevents rain gutters for clogging and, more particularly, a gutter guard that can be retrofitted to rain gutters.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### TECHNICAL FIELD

The invention described herein relates to an apparatus that prevents rain gutters from clogging and, more particularly, a gutter guard that can be retrofitted to rain gutters.

### BACKGROUND OF INVENTION

Rain gutters available on the market are attached on most, if not all, commercial and residential structures. The purpose of a rain gutter is to move water away from structures. It is recommended that rain gutters he cleaned at least once a year to remove any debris that may have accumulated and prevents water from moving through. Leaves, twigs, acorns, insects, vermin, and birds nest, amongst others, are considered debris because they clog the gutters and impede the natural flow of water away from the structure. However, depending on the location of the structure (e.g. those is heavily wooded areas) may need to be cleaned more often. Cleaning rain gutters is a time consuming and laborious task. Additionally, depending on the size and pitch of the roof, cleaning rain gutter can be quite dangerous. If debris is not cleaned from rain gutters the gutters will become a breeding ground for pests and animals and debris can cause damage to fascia boards, softis, and even the interior of the structure.

Attempts to solve the problem of clogged rain gutters take one of two forms: (1) the gutter is covered with a mesh or net, as shown in FIG. 1; or (2) the gutter is covered with a protective cap that channels water into the gutter, as shown in FIG. 2. Although the mesh and cap work well initially, they become clogged as water flows through and debris stays on top of the mesh or cap.

### BRIEF DESCRIPTION OF INVENTION

It is, therefore, an object of this invention to provide an improved rain gutter guard which allows water to move through a rain gutter while pushing away debris from the structure so that there is little or no need to clean the rain gutter area. Another object of this invention is to provide a rain gutter guard which can be retrofitted to any type of roofing.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is an exemplary drawing of prior art;

FIG. 2 is an exemplary drawing of prior art;

FIG. 3 is a perspective view of the invention described herein;

FIG. 4 is a side view of the invention described herein in a preferred embodiment;

FIG. 5 is an exploded view of the invention described herein;

FIG. 6a is a top view of the invention desribed herein;

FIG. 6b is a bottom view of the invention described herein;

FIG. 7 is a side view of the invention described herein in a preferred embodiment.

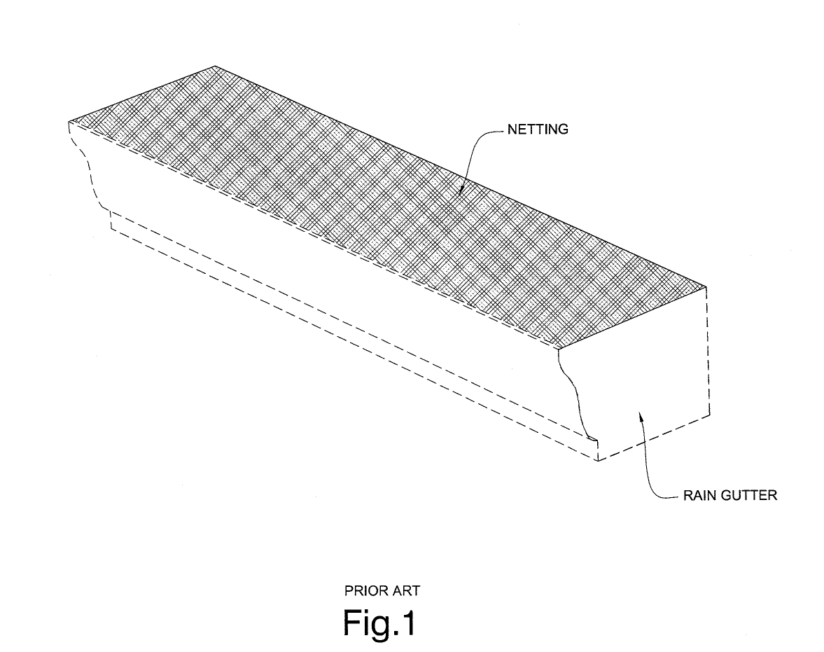

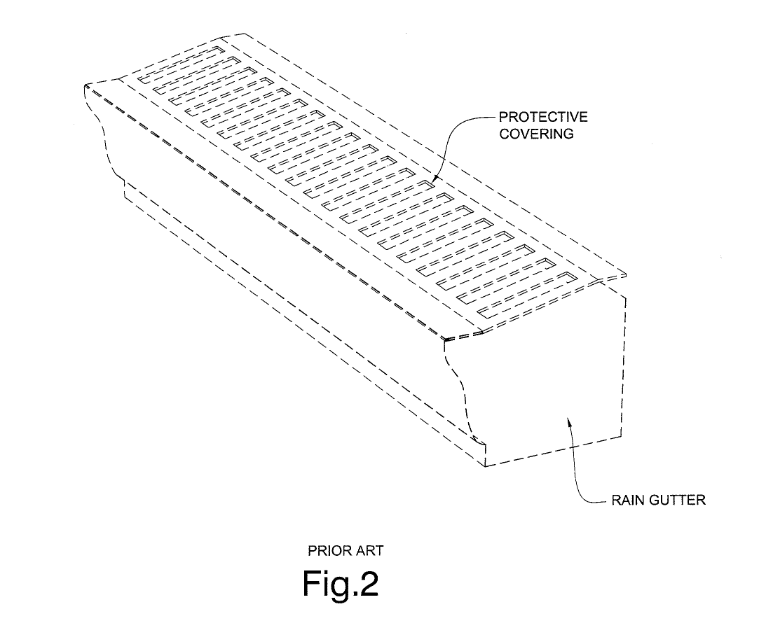

### DETAILED DESCRIPTION OF THE INVENTION

In the description of the invention above and in the detailed description of the invention, and the claims below, and in the accompanying drawings, reference is made to particular features (including method steps) of the invention. It is to be understood that the disclosure of the invention in this specification includes all possible combination of such particular features. For example, where a particular feature is disclosed in the context of a particular aspect or embodiment of the invention, or a particular claim, that feature can also be used, to the extent possible , combination with and/or in the context of other particular aspects and embodiments of the invention, and in the invention generally.

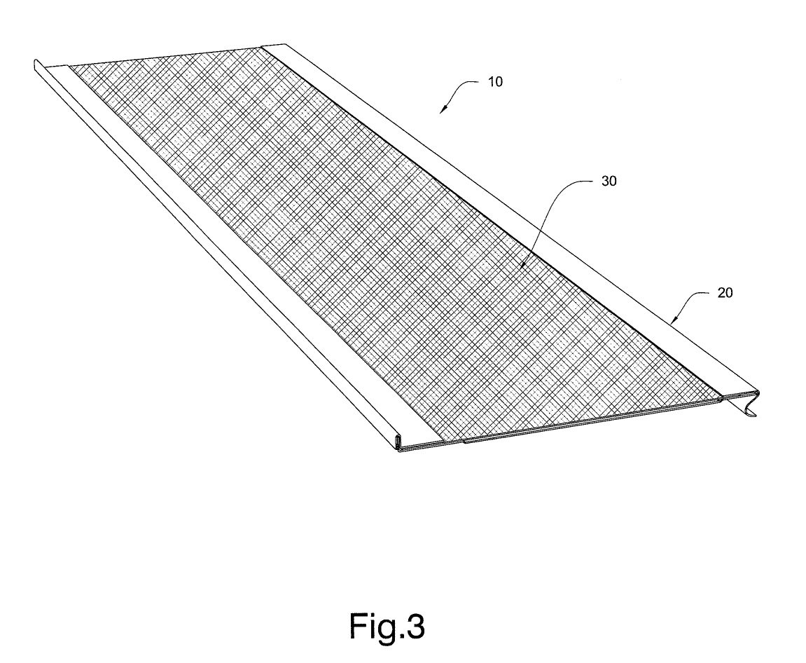

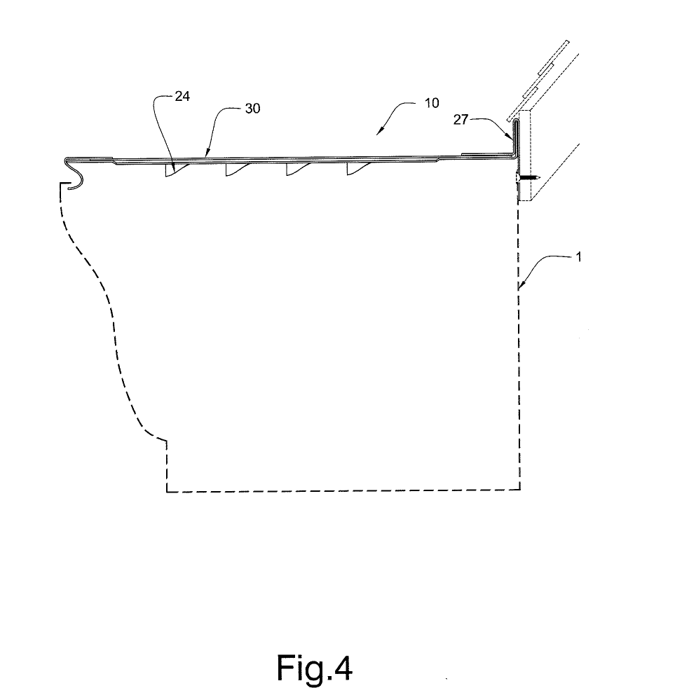

The invention described herein is a rain gutter guard (10) (herein referred to as “gutter guard” or “guard”) where FIG. 3 is a perspective view of the gutter guard (10). The gutter guard (10) can be installed when raingutters are installed or retro-fitted into a conventional rain gutter system. FIG. 4 is an exemplary side view of the gutter guard (10) installed on a conventional rain gutter (1) where a conventional rain gutter (1) is defined as a conduit which is secured to a support plate or fascia of the roof structure by conventional means.

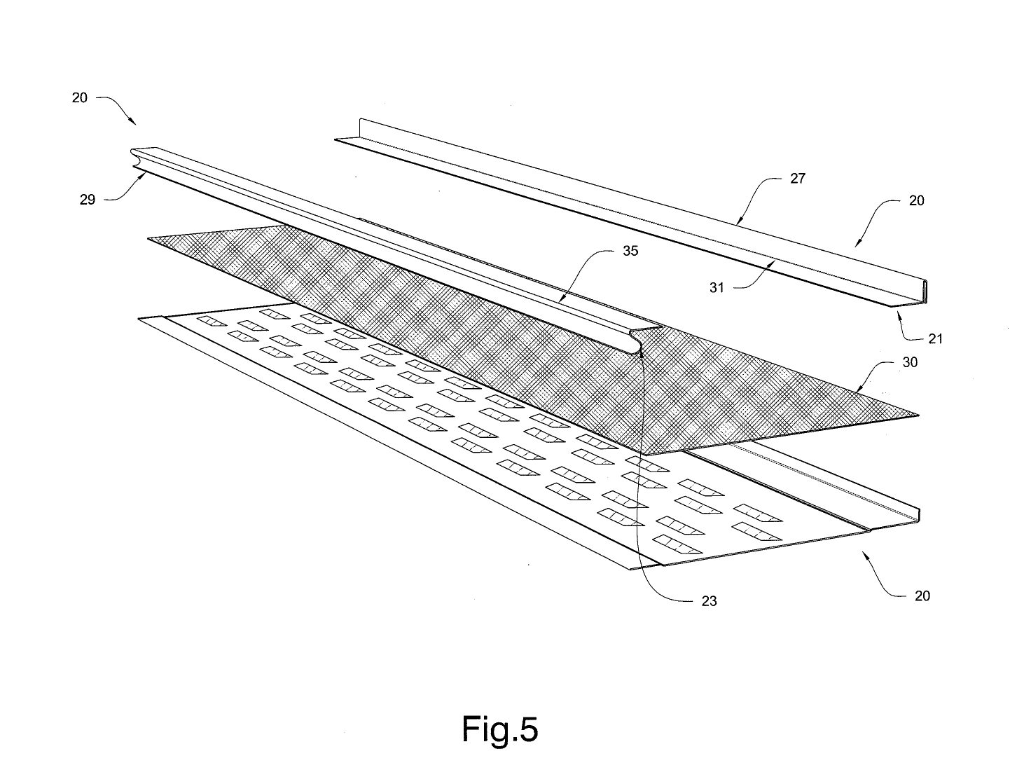

FIG. 5 is an exploded view of the of the gutter guard (10). The gutter guard is comprised of a guard shell (20) and mesh screen (30). In a preferred embodiment, the guard shell (20) is molded as an integral unit from plastic, vinyl, aluminum, or other water resistant material. Also, in a preferred embdiment, the mesh screen (30) is made of stainless steal. However, it will be obvious to a person having ordinary skill in the art that the mesh screen can be made from any sturdy, water proof material.

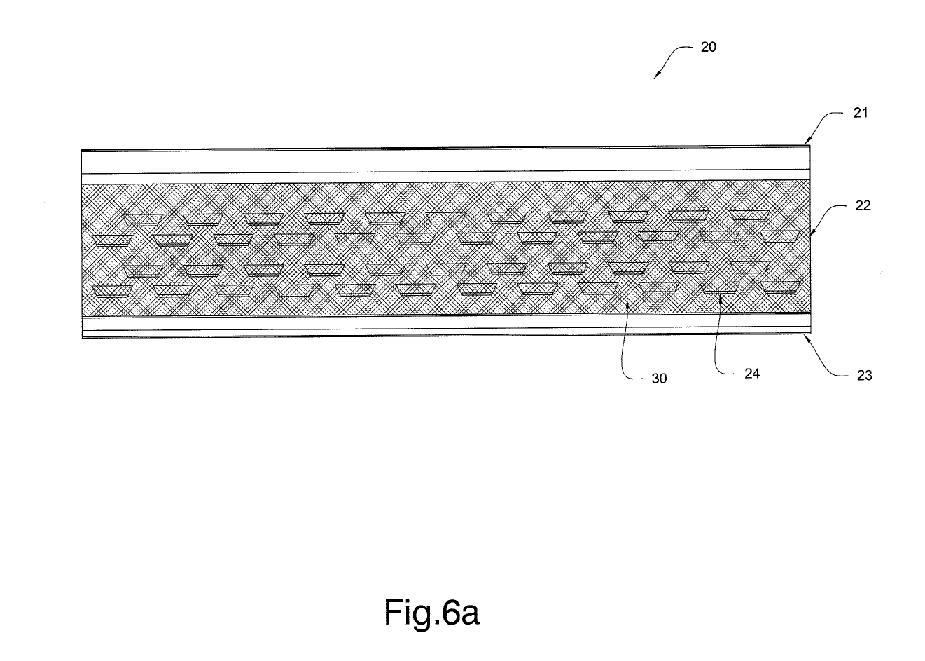

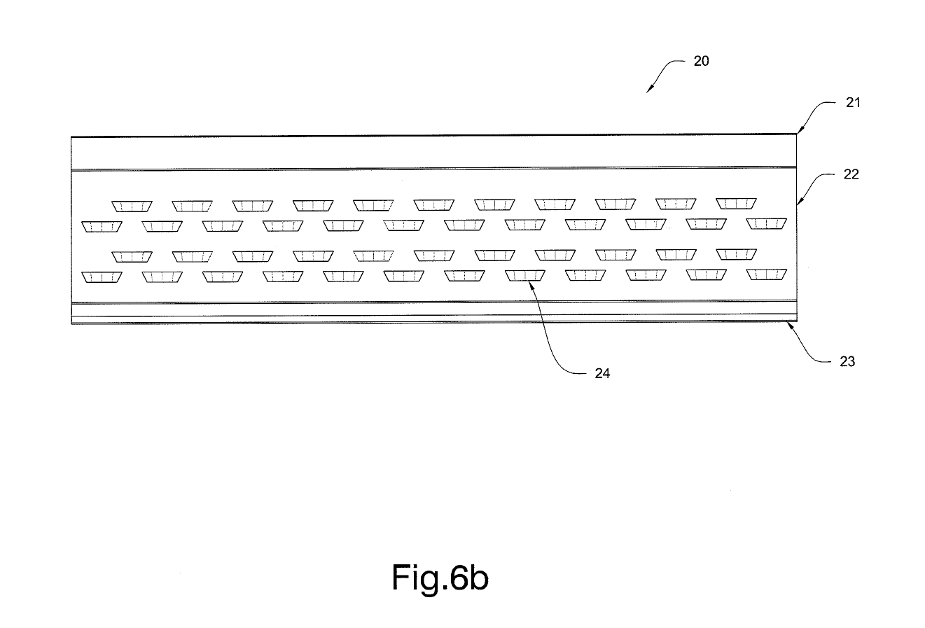

FIG. 6(a) top view of the guard shell (20) and FIG. 6(b) is a bottom view of the guard shell (20). Referring to FIG. 6(a), the guard shell (20) is comprised as three adjoining portions (21, 22, and 23). Portion (22) is sandwiched in between Portions (21) and (23). In a preferred embodiment, Portion (22) has a larger width than Portions (21) and (23). Portion (22) is machined to form louvers (24). Referring to FIG. 6(b), the louver (24) slats are on the back of Portion (22). Referring to FIG. 5, the mesh screen (30) is affixed to the guard shell (20) above the louvers (24) and is secured in place using Pittsburg Seams. In one preferred embodiment, there is space left between the guard shell (20) and the mesh screen (30).

Referring back to FIG. 5, Portion (21) forms a high wall (27). The high wall (27) creates a hinge point (31) or prebend which can be used for installation of the gutter guard (10). Portion (23) uses a Pittsburg Seam to form a hook (29) and lip (35).

The purpose of the louvers (24) is to pull and direct water away from the building structure and in toward the rain gutter (1). The pupose of the mesh screen (30) is to keep debris from entering the gutter and allowing easy removal. The high wall (27) prevents water from entering or being splashed onto the structure.

As discussed above, the gutter guard (10) can be placed on the rain gutter (1) before or after the rain gutter (1) has been installed onto the structure. Referring to FIG. 4, in one preferred method of installation, the rain guard (1) is put in place as the building structure is being constructed. The high wall (27) sits on top of a rain gutter hanger and bracket or a spike and ferrule connection with the louvres (24) facing the rain gutter (1) and the mesh screen (30) facing the sky. The rain guard (30) is secured in place by runing a screw through the high wall (27), through the building structure, and the bracket is used to secure the lip (30) to the building structure. Rain gutter hanger and bracket and spike and ferrule connections are well known in the art and therefore, are not discussed in detail here.

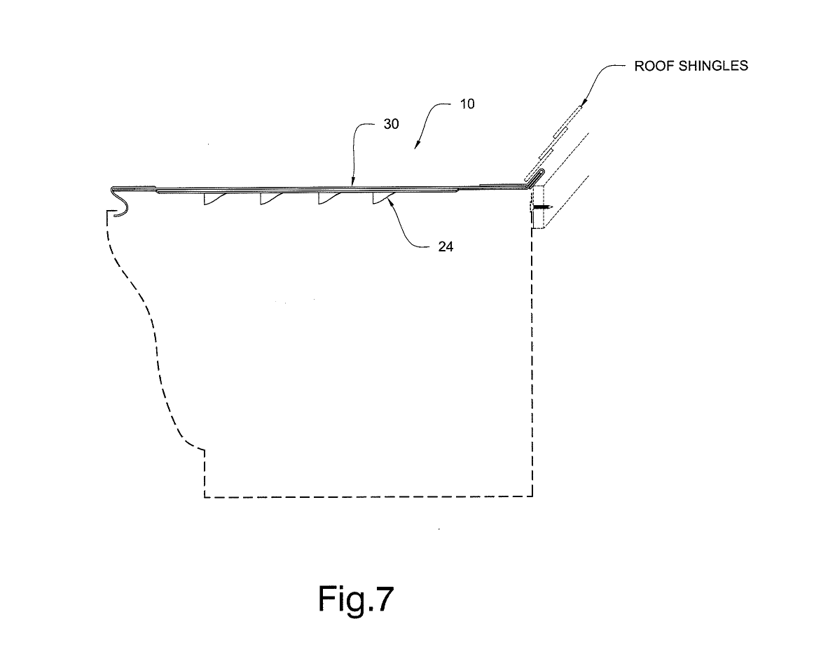

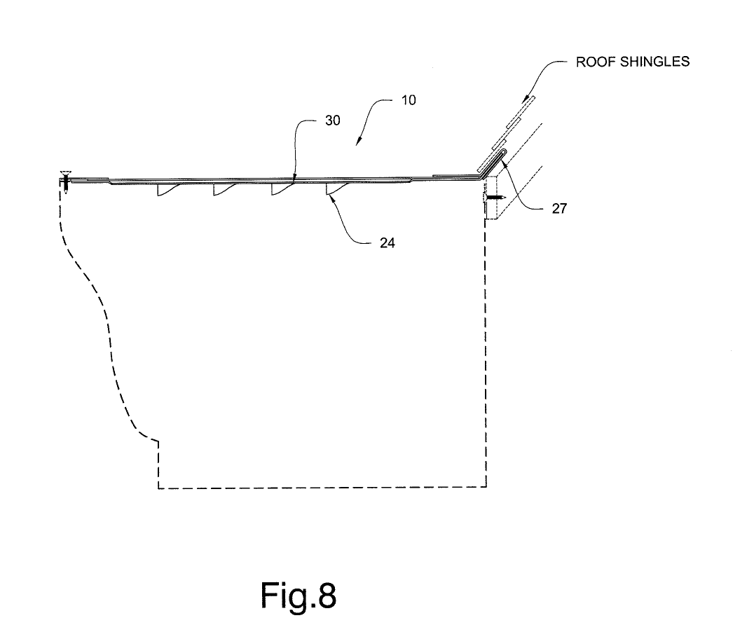

FIGS. 7 and 8 show two preferred means to install the gutter guard (10) after the roof has been installed onto the building structure. Referring to FIG. 7, in a one preferred method of installation, the hinge point/pre-bend (31) is flattened and tucked under roofing shingle. This method is used prior to gutter installation. Referring to FIG. 8, in a another preferred method of installation the high wall (27) rests on on a bracket or ferrule connections and is held in place by the roof and gravity. This lip (30) of the gutter guard (10) is screwed to the building structure using a screw.

1. A rain gutter guard where said rain gautter guard is comprised of a guard shell and mesh screen.

2. The rain gutter guard of claim 1 where the guard shell is comprised of three adjoining portions where said portions comprise a left, right and middle portion; said middle portion is sandwiched between the left and right portions and has a top side and a bottom side.

3. The rain gutter guard of claim 2 where the middle portion is machined to form louvers where the louver slats protrude from the back of the middle portion.

4. There rain gutter guard of claim 3 where the mesh screen sits over the louvers.

5. The rain gutter guard of claim 3 where there is a small space left between the mesh screen and the louvres.

6. The rain gutter guard of claim 5 where the right portion forms a high wall.

7. The rain gutter guard of claim 6 where the high wall creates a hinge point or prebend.

8. The rain gutter guard of claim 5 where the left portion uses a Pittsburg Seam to form at least a hook and lip.

9. A method to install a rain gutter guard comprising: (a) placing the high wall on top of a rain gutter hanger and bracket or a spike and ferrule connection with the louvres slats facing a rain gutter and the mesh screen facing the sky; (b) securing the rain guard to a structure.

10. A method to install a rain gutter guard comprising flattening the hinge point/pre-bend and tucking under roofing shingle.
